(19) United States
(12) Patent Application Publication
(10) Pub. No.: US 2013/0174727 A1
(43) Pub. Date: Jul. 11, 2013

(54) CYLINDER LENGTH SENSOR MOUNTING/RETAINING ASSEMBLY

(71) Applicants: Christopher L. Palmer, McConnellsburg, PA (US); Lex A. Mellott, McConnellsburg, PA (US)

(72) Inventors: Christopher L. Palmer, McConnellsburg, PA (US); Lex A. Mellott, McConnellsburg, PA (US)

(73) Assignee: JLG INDUSTRIES, INC., Hagerstown, MD (US)

(21) Appl. No.: 13/876,112

(22) PCT Filed: Oct. 25, 2011
(86) PCT No.: PCT/US11/57624

§ 371 Date: Mar. 26, 2013

Related U.S. Application Data
(60) Provisional application No. 61/406,698, filed on Oct. 26, 2010.

(51) Int. Cl. F15B 15/20

(52) U.S. Cl. CPC F15B 15/20
USPC 92/161; 29/888.06

(57) ABSTRACT

A cylinder length sensor mounting and retaining assembly for a hydraulic cylinder includes a casing attachable to a blind end of the cylinder, a sensor retention cap affixable to the casing adjacent the blind end of the cylinder, and a locking pin extendable through the casing and positioned adjacent the sensor retention cap. The assembly facilitates sensor removal without requiring disassembly of the cylinder.

This application claims the benefit of U.S. Provisional Patent Application Ser. No. 61/406,698, filed Oct. 26, 2010, the entire content of which is herein incorporated by reference.

### BACKGROUND OF THE INVENTION

The invention relates to a sensor mounting/retaining assembly and, more particularly, to a cylinder length sensor mounting/retaining assembly that facilitates access to the sensor without requiring disassembly of the cylinder.

Magnetostrictive length sensors can be incorporated into hydraulic cylinders. The sensors accurately measure a linear position of the cylinder rod. In incorporating such sensors into hydraulic cylinders, in the event a sensor needs to be repaired or replaced, existing designs require disassembly of the cylinder to access the sensor. FIG. 1 is a cross-section through an exemplary prior art installation from the head end of the cylinder barrel, and FIG. 2 is a cross-section of an exemplary prior art installation through the blind end of the cylinder barrel. In the FIG. 1 installation, access to the sensor requires complete disassembly of the cylinder. Similarly, in the FIG. 2 installation, at least the rear structure of the cylinder must be disassembled to access the sensor. Moreover, the bolts shown in FIG. 2 are subjected to cylinder forces, which far exceed the pressures acting on the sensor.

Additionally, existing sensors include an electrical connector of a two-piece construction that can be disassembled for sensor removal without soldering or removal of separate pins/conductors. The existing electrical connector, however, requires the use of four small fasteners. Corresponding threads are typically machined into the barrel weldment. This is a disadvantage since damage to the threads could possibly ruin the entire barrel weldment or at a minimum require excessive repair costs. Once the small fasteners are removed, the existing connector can be unsnapped into halves, allowing the sensor to be removed.

### SUMMARY OF THE INVENTION

It would be desirable to provide a cylinder length sensor mounting/retaining assembly that facilitates access to the sensor without requiring disassembly of the cylinder. It would also be desirable to provide a design that does not require disassembly of the connector when removing the sensor from the cylinder. Such a design increases the reliability of the sensor since it does not require an electrical junction at the cylinder.

In an exemplary embodiment, a cylinder length sensor mounting and retaining assembly for a hydraulic cylinder includes a casing attachable to a blind end of the cylinder and a sensor retention cap affixable adjacent the blind end of the cylinder to close a sensor receiving channel. A first channel extends through the casing and is oriented substantially in alignment with the sensor receiving channel, and a second channel extends through the casing and intersects the first channel. A locking pin is extendable through the second channel, where the second channel is positioned relative to the sensor retention cap such that with the locking pin extending through the second channel, the locking pin is disposed adjacent the sensor retention cap.

The second channel may be substantially perpendicular to the first channel. In one arrangement, the sensor retention cap is secured to the casing with a plurality of mounting bolts. The second channel may be defined by separate and aligned pin receiving sections, where the first channel bisects the pin receiving sections. In this context, with the locking pin extending through the second channel, the locking pin may be positioned to block the first channel. In this context, the locking pin may be spaced from sensor retention cap by an amount that prevents the sensor retention cap from moving enough to leak. The sensor retention cap may include a sensor retention cap cavity that is sized to receive the cylinder length sensor. In this context, the sensor retention cap cavity may be shaped such that it is positively draining and allows moisture to exit freely from the cavity. The assembly may include an overmolded cordset through which a control module connector extends without requiring an electrical junction at the cylinder. The cordset is preferably long enough to attach to a cylinder control module.

In another exemplary embodiment, a cylinder length sensor mounting and retaining assembly for a hydraulic cylinder includes a casing attachable to a blind end of the cylinder, a sensor retention cap affixable to the casing adjacent the blind end of the cylinder, and a locking pin extendable through the casing and positioned adjacent the sensor retention cap.

In yet another exemplary embodiment, a method of mounting and retaining a cylinder length sensor in a hydraulic cylinder includes the steps of securing a casing to a blind end of the cylinder; affixing a sensor retention cap to the casing adjacent the blind end of the cylinder; and positioning a locking pin through a channel in the casing such that the locking pin is disposed adjacent the sensor retention cap.

The positioning step may be practiced by defining a first channel that extends through the casing and is oriented substantially in alignment with a sensor receiving channel, by defining a second channel extending through the casing and intersecting the first channel, and by extending the locking pin through the second channel positioned relative to the sensor retention cap such that with the locking pin extending through the second channel, the locking pin is disposed adjacent the sensor retention cap.

### BRIEF DESCRIPTION OF THE DRAWINGS

These and other aspects and advantages will be described in detail with reference to the accompanying drawings, in which:

FIG. 1 is a sectional view through an existing cylinder arranged for sensor assembly form the head end of the cylinder barrel;

FIG. 2 is a sectional view of an existing cylinder arranged for sensor assembly through the blind end of the cylinder barrel;

FIGS. 3-6 show the cylinder length sensor mounting and retaining assembly of the described embodiments; and

FIG. 7 is a section view showing the cylinder length sensor mounting and retaining assembly.

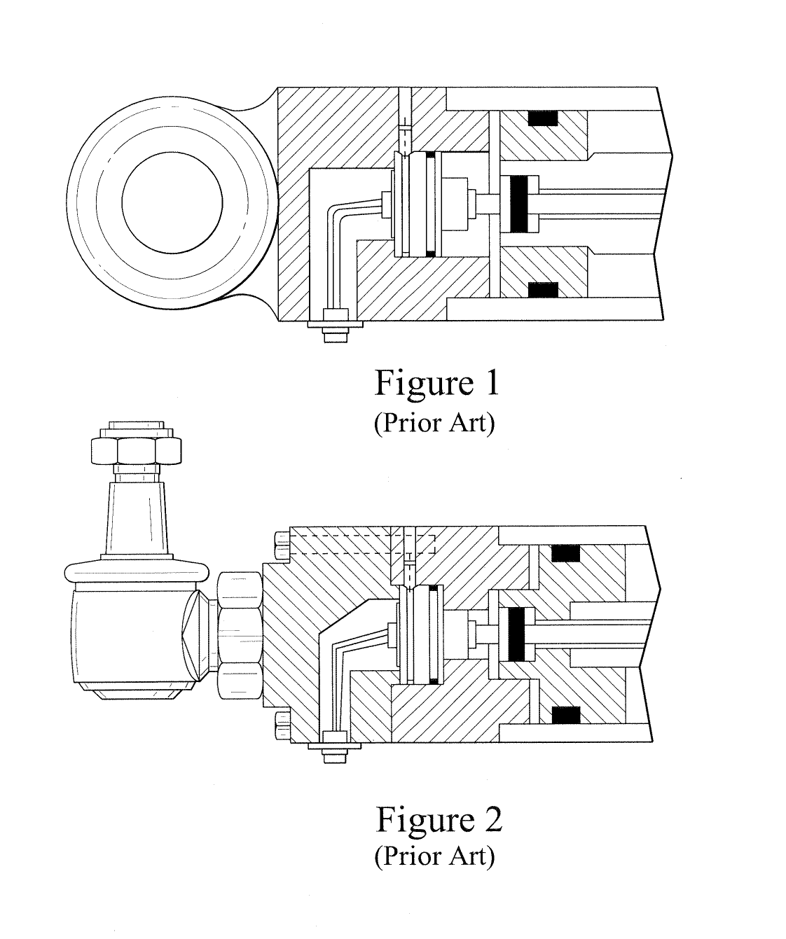

### DETAILED DESCRIPTION OF THE DRAWINGS

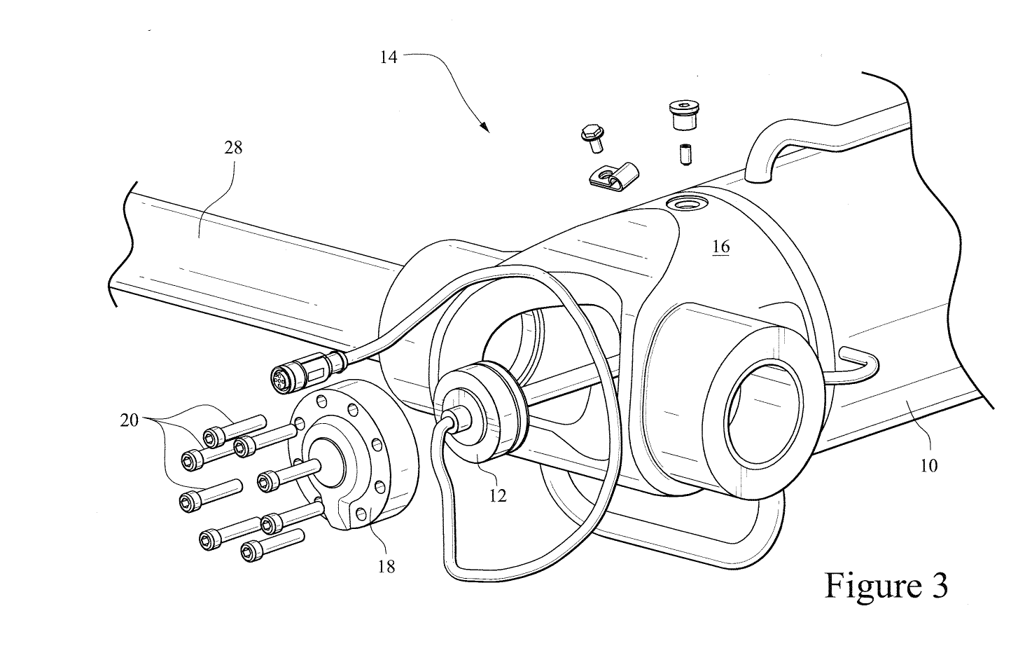

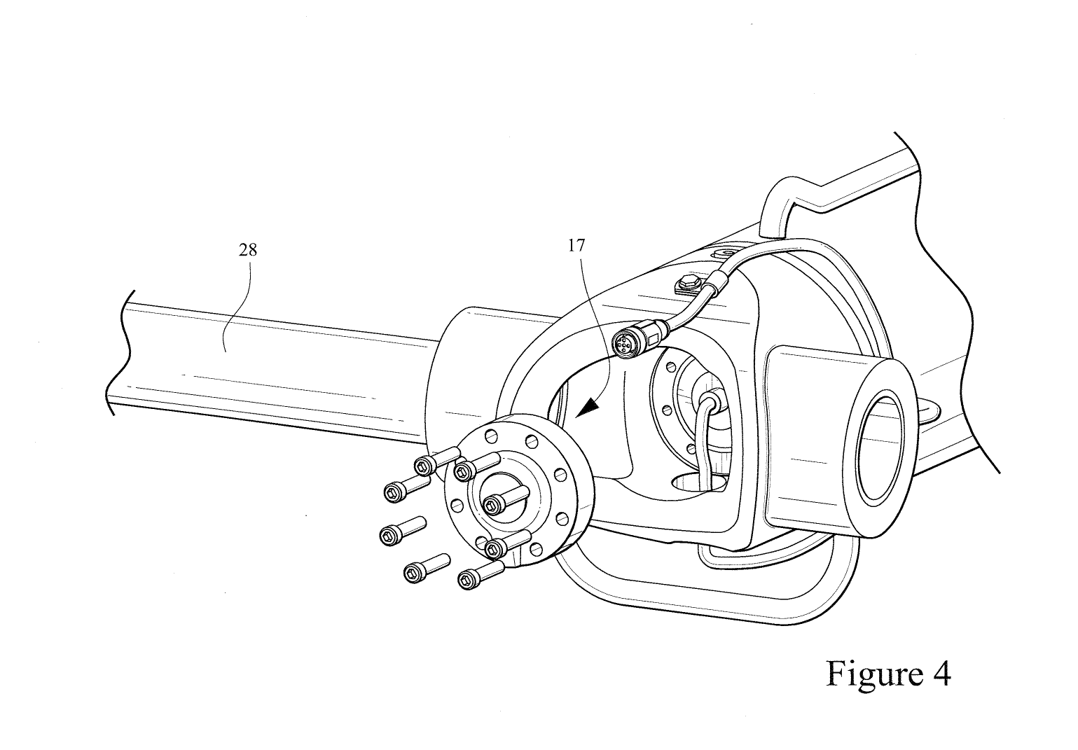

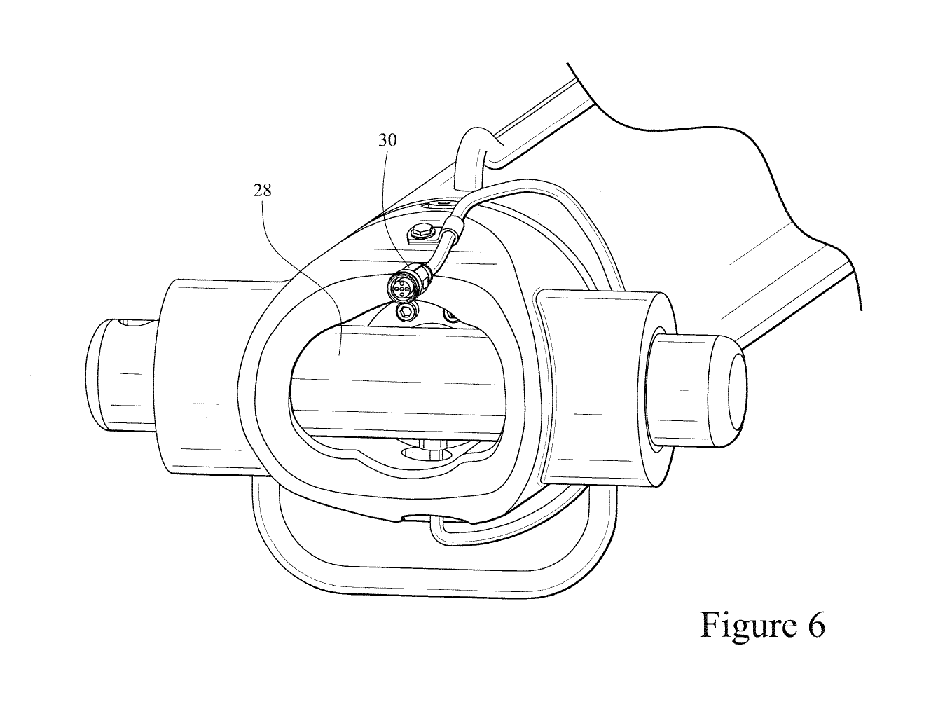

With reference to FIGS. 3-7, a hydraulic cylinder 10 is shown including a linear sensor 12 that is incorporated into the cylinder 10. A cylinder length sensor mounting and retaining assembly 14 serves to secure and retain the sensor 12 in the cylinder 10.

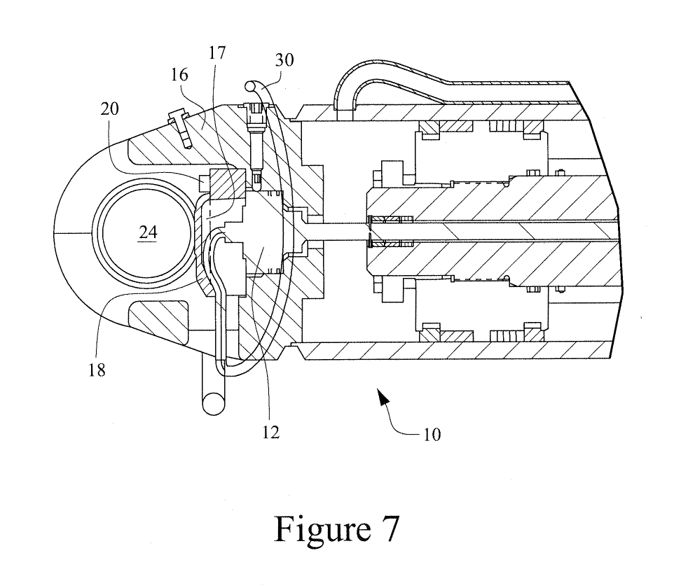

The assembly 14 includes a casing 16 attachable to a blind end of the cylinder 10 (as shown in FIG. 3). A sensor retention cap 18 is affixable to the casing 16 via suitable fasteners 20 adjacent the blind end of the cylinder 10 to close a sensor receiving channel. Preferably, the retention cap 18 is provided with a sensor retention cap cavity 17 that is shaped such that it is positively draining and allows moisture to exit freely from the cavity through a hole in the casing 16 (see FIG. 7). That is, a mounting face of the sensor retention cap cavity 17 is recessed in a counter bore so that exterior moisture (e.g., water from blowing rain, power washing, etc.) has a tortured path to reach the mounting interface. Additionally, the sensor cap cavity 17 is provided with a large drain area to allow any ingressed water or condensation to drain. The sensor retention cap cavity 17 also prevents condensation build-up in the cavity, which could possibly lead to moisture ingress at the back end of the sensor.

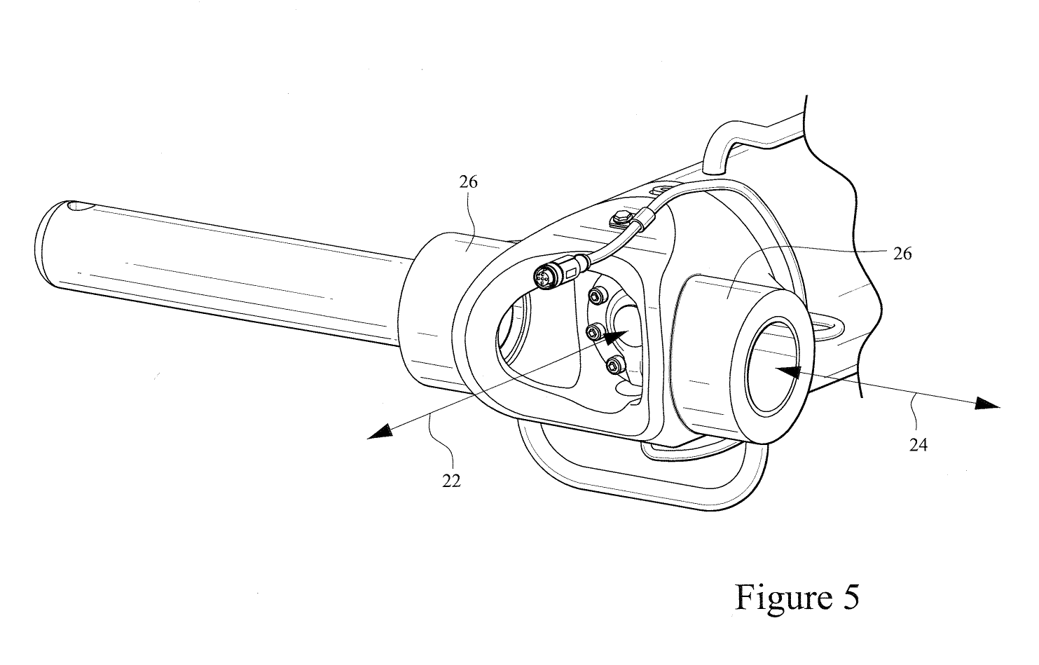

As shown in FIG. 5, a first channel or bore 22 extends through the casing 16 and is oriented substantially in alignment with the sensor receiving channel. A second channel or bore 24 extends through the casing 16 and intersects the first channel 22. Preferably, the second channel 24 is substantially perpendicular to the first channel 22. The second channel 24 may be defined by separate and aligned pin receiving sections 26. As shown in FIG. 5, the first channel 22 bisects the pin receiving sections 26.

A locking pin 28 is extendible through the second channel 24. The locking pin 28 is the cylinder pivot pin that serves to secure the cylinder to adjoining structure. As shown, the second channel 24 is positioned relative to the sensor retention cap 18 such that with the locking pin 28 extending through the second channel 24, the locking pin 28 is disposed adjacent the sensor retaining cap 18. In this context, with the locking pin 28 extending through the second channel 24, the locking pin 28 is positioned to block the first channel 22.

The sensor retention cap 18 secured to the sensor retention cap cavity 17 is mechanically separate from the main structure of the cylinder 10. As such, the mounting bolts 20 need only accommodate the pressures/forces acting on the sensor (as opposed to the entire cylinder as in the prior art design shown in FIG. 2). If the mounting bolts 20 were to loosen or fail, the retention cap 18 is restricted to small linear movement until it contacts the locking pin 28. The position of the locking pin 28 relative to the retention cap 18 is small enough such that it does not allow the sensor seal to disengage. As a consequence, sudden/rapid leak-down of the cylinder is prevented.

In order to access the sensor 12, after removing the locking pin 28 only the retention cap 18 needs to be removed, and disassembly of the cylinder is not required.

In order to avoid requiring disassembly of the connector when removing the sensor 12 from the cylinder 10, the design utilizes an over-molded cordset 30. The cordset 30 includes a cable and plug connector integrated into a single piece with the insulation over-molded to provide strain relief and moisture protection. This structure increases the reliability of the sensor since it does not require an electrical junction at the cylinder 10. The cordset 30 could be long enough to attach directly to the control module/machine interface or to another harnass, an I/O board, a terminal strip, etc. The prior design requires a cable to extend from the cylinder to the control module.

The cylinder length sensor mounting/retaining assembly serves to securely retain a length sensor within a hydraulic cylinder while providing access to the sensor without requiring disassembly of the cylinder. The structure prevents the sensor seal from disengaging in the event that the sensor retention cap mounting bolts were to loosen or fail. Additionally, the use of an over-molded cordset does not require disassembly of the connector when removing the sensor from the cylinder.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

What is claimed is:

1. A cylinder length sensor mounting and retaining assembly for a hydraulic cylinder, the assembly comprising:
a casing attachable to a blind end of the cylinder;
a sensor retention cap affixable adjacent the blind end of the cylinder to close a sensor receiving channel;
a first channel extending through the casing and oriented substantially in alignment with the sensor receiving channel, the first channel having open ends such that the sensor retention cap can be affixed or removed with the casing attached to the cylinder;
a second channel extending through the casing and intersecting the first channel; and
a locking pin extendable through the second channel, wherein the second channel is positioned relative to the sensor retention cap such that with the locking pin extending through the second channel, the locking pin is disposed adjacent the sensor retention cap.

2. An assembly according to claim 1, wherein the second channel is substantially perpendicular to the first channel.

3. An assembly according to claim 1, wherein the sensor retention cap is secured to the casing with a plurality of mounting bolts.

4. An assembly according to claim 1, wherein the second channel is defined by separate and aligned pin receiving sections, and wherein the first channel bisects the pin receiving sections.

5. An assembly according to claim 4, wherein with the locking pin extending through the second channel, the locking pin is positioned to block the first channel.

6. An assembly according to claim 5, wherein the locking pin is spaced from sensor retention cap by an amount that prevents the sensor retention cap from moving enough to leak.

7. An assembly according to claim 1, wherein the sensor retention cap comprises a sensor retention cap cavity that is sized to receive a cylinder length sensor.

8. An assembly according to claim 7, wherein the sensor retention cap cavity is shaped such that it is positively draining and allows moisture to exit freely from the cavity.

9. An assembly according to claim 1, further comprising an overmolded cordset through which a control module connector extends without requiring an electrical junction at the cylinder.

10. An assembly according to claim 9, wherein the cordset is long enough to attach directly to a cylinder control module.

11. An assembly according to claim 1, wherein the locking pin is a pivot pin that is connectable to adjoining structure on which the hydraulic cylinder acts.

12. A cylinder length sensor mounting and retaining assembly for a hydraulic cylinder, the assembly comprising:
a casing attachable to a blind end of the cylinder, the casing including a channel therethrough with first and second open ends;
a sensor retention cap affixable to the second open end of the casing through the first open end of the casing adjacent the blind end of the cylinder; and
a locking pin extendable through the casing and positioned adjacent the sensor retention cap.

13. An assembly according to claim 12, wherein the sensor retention cap is secured to the casing with a plurality of mounting bolts.

14. An assembly according to claim 12, wherein the sensor retention cap comprises a sensor retention cap cavity that is sized to receive a cylinder length sensor.

15. An assembly according to claim 14, wherein the sensor retention cap cavity is shaped such that it is positively draining and allows moisture to exit freely from the cavity.

16. An assembly according to claim 12, further comprising an overmolded cordset through which a control module connector extends without requiring an electrical junction at the cylinder.

17. An assembly according to claim 16, wherein the cordset is long enough to attach to a cylinder control module.

18. A method of mounting and retaining a cylinder length sensor in a hydraulic cylinder, the method comprising:
securing a casing to a blind end of the cylinder; then
affixing a sensor retention cap to the casing adjacent the blind end of the cylinder; and then
positioning a locking pin through a channel in the casing such that the locking pin is disposed adjacent the sensor retention cap.

19. A method according to claim 18, wherein the positioning step is practiced by defining a first channel that extends through the casing and is oriented substantially in alignment with a sensor receiving channel, by defining a second channel extending through the casing and intersecting the first channel, and by extending the locking pin through the second channel positioned relative to the sensor retention cap such that with the locking pin extending through the second channel, the locking pin is disposed adjacent the sensor retention cap.
